(19) United States
(12) Patent Application Publication
(10) Pub. No.: US 2020/0026869 A1
(43) Pub. Date: Jan. 23, 2020

(54) SYSTEMS AND METHODS FOR IDENTIFICATION OF A MARKER IN A GRAPHICAL OBJECT

(71) Applicant: Vidit, LLC, Layton, UT (US)

(72) Inventors: Rene Rodriguez, Layton, UT (US); George Michael Theodore, Greensboro, NC (US); Rodrigo Moya, Layton, UT (US)

(21) Appl. No.: 16/506,825

(22) Filed: Jul. 9, 2019

Related U.S. Application Data
(60) Provisional application No. 62/699,551, filed on Jul. 17, 2018.

(51) Int. Cl. G06F 21/62; G06T 11/00; G06K 9/62; G06K 7/14; G06F 16/955

(52) U.S. Cl. CPC G06F 21/6218; G06T 11/00; G06F 16/9554; G06K 7/1417; G06K 7/1413; G06K 9/6215

(57) ABSTRACT

A system for identification of attributes in a graphical object is disclosed. The system includes a scanning module configured to enable a user to scan an object to generate a graphical object. The system further includes an identification module configured to identify one or more attributes hidden in the graphical object. The one or more attributes includes a face or a quick response (QR) code. The identification module is also configured to search a database to find one or more attributes identical to one or more attributes visible in the graphical object. The system further includes a processing module configured to center the graphical object in the view of the user when a marker is identified or center the graphical object in the view of the user and send a query to a server when the one or more attributes are identified in the database.

### CROSS-REFERENCED APPLICATIONS

This application claims priority to U.S. Provisional Patent Application No. 62/699,551 filed on Jul. 17, 2018.

### BACKGROUND

One of the vast applications of the internet is social media, which broadly defined are computer-mediated technologies that facilitate the creation and sharing of information, ideas and other forms of expression via virtual communities and networks. Using such services, social media platforms may engage individuals, communities, and organizations to share, co-create, discuss, and modify user-generated content or pre-made content posted online.

### SUMMARY

Some attempts have been made to extract information from databases using images themselves as search entities rather than keywords related to the images. Such systems may translate, provide information about, or interpret objects contained in the image. Such systems generally work by first extracting an object or objects of interest from the background of the image. The object is compared with objects stored in a database to find a match. Finally, the system retrieves information in the database about the object and authorizes the information to be displayed to the user. Such systems are generally limited to processing images containing extractable, defined objects, which can be easily outlined. However, several images require identification as a whole entity, such as an image of a geographic location, a QR code or a piece of artwork. As a result, such systems have limited applicability. Also, such systems are sometimes unable to provide complete information about the image because the image may get cropped while taking the photograph of a scene. The present invention allows features or attributes within an image to be separately identified and then searched to aid in identifying a whole image. Data on the location of the user when capturing the entire image may be compared to data of the capture location of search results of similar attributes taken from the whole image.

This summary is provided to introduce a selection of concepts, in a simple manner, which are further described in the detailed description of the invention. This summary is neither intended to identify key or essential inventive concepts of the subject matter, nor to determine the scope of the invention.

In accordance with an embodiment of the present invention, a system for identification of a marker in a graphical object is provided. The system includes a scanning module configured to enable a user to scan an object to generate a graphical object, for example a video or a still image. The system further includes an identification module operatively coupled to the scanning module. The identification module is configured to identify one or more attributes hidden in the graphical object. The one or more attributes includes a face or a quick response (QR) code, a bar code or a tag. The identification module is also configured to search a database to find one or more attributes identical to or similar to one or more attributes visible in the graphical object when search or the entire image are not successful. When an image is captured, optionally a geo-marker is set at the geographical location of the image capture. A program on a smartphone may be used to locate all geo-markers in a set geographical area and display them on a map. The system further includes a processing module operatively coupled to the identification module. The processing module is located as a program on a smartphone and is configured to center a graphical object on a geo-marker in the view of the user when one or more geo-markers are identified. A user may then identify the exact location of the user when an image is captured by comparing the perspectives of the same object when captured by different users with slightly different geolocations. The program may also access a database to provide geo-markers from other users attached to images captured in the vicinity of the user. The processing module is also configured to center the graphical object in the view of the user and send a query to a server when the one or more attributes are identified in the database. The system includes a server which is communicatively coupled to the processing module. The server is configured to provide an information associated with the graphical object based on a viewing permission.

In accordance with another embodiment of the present disclosure, a method for identification of a digital marker in a graphical object is provided. The method includes enabling a user to scan an object to generate a digital graphical object using a scanning module. The method also includes identifying one or more digital markers located nearby, when at the location of a local digital marker. When analyzing a scanned image the image captured by the original author is centered. The method further includes searching a database to find one or more attributes identical to one or more articles visible in the graphical object when the one or more first attributes are unavailable. The method further includes centering the graphical object in the view of the user when the one or more markers are identified. The method further includes centering the graphical object in the view of the user and sending a query to a server when the one or more attributes are identified in the database. The method includes providing an information associated with the graphical object based on a viewing permission.

To further clarify the advantages and features of the present invention, a more particular description of the invention will follow by reference to specific embodiments thereof, which are illustrated in the appended figures. It is to be appreciated that these figures depict only typical embodiments of the invention and are therefore not to be considered limiting in scope. The invention will be described and explained with additional specificity and detail with the appended figures.

### BRIEF DESCRIPTION OF DRAWINGS

The disclosure will be described and explained with additional specificity and detail with the accompanying figures in which:

FIG. 1 is a block diagram of a system for identification of a marker in a graphical object in accordance with an embodiment of the present disclosure;

FIG. 2 is a block diagram of an exemplary embodiment of the system for identification of the marker in the graphical object of FIG. 1 in accordance with an embodiment of the present disclosure; and

FIG. 3 is a flow chart representing the steps involved in a method of identification of the marker in the graphical object of FIG. 1 in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present invention so as not to obscure the figures with details that will be readily apparent to those skilled in the art having the benefit of the description herein.

### DETAILED DESCRIPTION OF THE INVENTION

For the purpose of promoting an understanding of the principles of the invention, reference will now be made to the embodiment illustrated in the figures and specific language will be used to describe them. It will nevertheless be understood that no limitation of the scope of the invention is thereby intended. Such alterations and further modifications in the illustrated system, and such further applications of the principles of the invention as would normally occur to those skilled in the art are to be construed as being within the scope of the present invention.

It will be understood by those skilled in the art that the foregoing general description and the following detailed description are exemplary and explanatory of the invention and are not intended to be restrictive thereof.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or sub-systems or elements or structures or components preceded by “comprises . . . a” does not, without more constraints, preclude the existence of other devices, sub-systems, elements, structures, components, additional devices, additional sub-systems, additional elements, additional structures or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this invention belongs. The system, methods, and examples provided herein are only illustrative and not intended to be limiting.

Embodiments of the present invention will be described below in detail with reference to the accompanying figures.

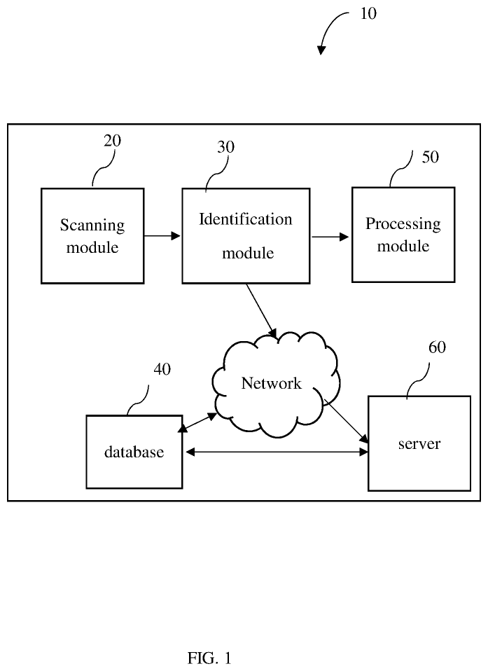

FIG. 1 is a block diagram of a system 10 for identification of a marker in a graphical object in accordance with an embodiment of the present disclosure. The system 10 includes a scanning module 20 configured to enable a user to scan an object to generate a graphical object. In one embodiment, the graphical object may include an image, a video, an augmented reality video or a virtual reality video. In some embodiments, the graphical object may be obtained from a visual entity, a printed material, an electronic display unit, or a projected visual information. In such embodiments, the scanning module 20 may include a camera or a scanner of the portable electronic device.

The system 10 further includes an identification module 30 operatively coupled to the scanning module 20. The identification module 30 is configured to identify one or more markers hidden in the graphical object. The one or more markers includes a face, a barcode, a digital marker or a quick response (QR) code. The identification module 30 is also configured to search a database 40 to find one or more attributes identical to one or more articles visible in the graphical object when the one or more attributes are unavailable. In one embodiment, the identification module 30 searches an image library in the database 40 to identify if one or more articles present in the image is identical to one or more attributes in the image library.

In such embodiment, attributes are the collection of elements within the graphical object, while articles are singled out elements of the graphical object considered separately from the graphical object itself. By way of non-limiting example, an image can be generated of a city street with several buildings. The set of several buildings collectively, along with any markers hidden in the graphical object, are attributes of the image. In the case that no other image in the image library contains the same set of attributes (the set of buildings), the identification module 30 can be configured to separate out each building in the image as a separate article. The identification module 30 can then be configured to search the database 40 for attributes in images in the image library (prior images comprising one or more buildings found in the new city street image) that match an article from the new image (a single building from the new image). By focusing on one or more individual articles of the graphical object when the exact combination of one or more attributes cannot be found in the image library, the identification module 30 is able to broaden the scope of its search and more accurately associate images from the database 40 with the newly generated graphical object.

The system 10 further includes a processing module 50 operatively coupled to the identification module 30. The processing module 50 is configured to center the graphical object in the view of the user when the one or more markers are identified. The processing module 50 is also configured to center the graphical object in the view of the user and send a query to a server 60 when the one or more attributes are identified in the database 40. In a specific embodiment, the server 60 is configured to identify a viewing permission for a centered graphical object. If the access is limited, the server 60 determines if the viewer is part of the class that nevertheless has access. In such embodiment, the limitation on the graphical object may include a limitation of a date of view, a limitation of a location of the viewer or a plurality of aspect of the viewer that the system 10 knows about the viewer and notify the server 60.

The server 60 is further configured to provide an information associated with the graphical object based on a viewing permission. In a specific embodiment, the information associated with the graphical object may include a location information, a translation information, a historic description or a current news. In some embodiments, the information associated with the marker may be obtained from online educational sources such as books, encyclopedias, dictionaries, translators, and the like. In one embodiment, the server 60 is further configured to create a marker for the graphical object of the scanned view.

In one embodiment, the server 60 creates a marker by embedding one or more attributes in the graphical object. In such embodiment, the one or more attributes may include a barcode, a QR code, a digital tag, a video, an augmented reality video, a 3-dimensional content, a hyperlink or a text. In a specific embodiment, the server 60 centers the graphical object in the view of the user when the one or more markers is created. In some embodiments, the sever 60 may embed the viewing permission in the image. In such embodiment, the viewing permission may include a private permission representative of a permission to one or more specific people to view the image and a public permission representative of a permission to any person to view the image. After embedding the viewing permission in the image, the user sends the image to the database 40 of the server 60.

In one embodiment, the database 40 uses the one or more embedded attributes to create links between related images. In such embodiment, this can assist in categorizing similar images in the image library, identifying groups of similar images with the identification module 30, and producing more relevant information associated with the image. This embodiment can facilitate ease of use and potential monetization of the system 10 through providing relevant advertisements.

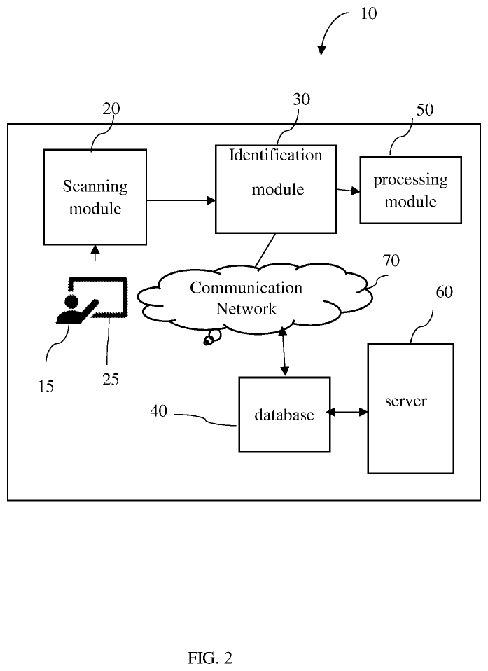

FIG. 2 is a block diagram of an exemplary embodiment of the system 10 for identification of a marker in a graphical object of FIG. 1 in accordance with an embodiment of the present disclosure. A user 15 operates a portable electronic device 25 such as a hybrid PDA or a cellular telephone with camera attachment in order to capture or scan a view of a predefined location. The system 10 is installed in the portable electronic device 25 of the user. For example, considering a scenario where the user 15 with the system 10 installed on a portable electronic device 25 is looking through the viewfinder on the portable electronic device 25 at an image, a wall inside a building with a painting on the wall.

The scanning module 20 of the system 10 in synchronization with the camera of the portable electronic device 25 enable the user to scan a view to generate an image of a digital view. The identification module 30 of the system 10 then identifies if the image includes a face, a barcode, a digital marker or a QR code or a similar code. The processing module 50 of the system 10 then sets the image as a marker and centers the image in the view of the user. If the image is not set as a digital geographic marker and the identification module 30 is unable to find the face or the QR code in the image, then the identification module 30 searches something in the image library of the database 40 that is identical or very similar to anything in the image. The processing module 50 in this case also, centers the image in the view of the user 15 and sends the query to the server 60.

The server 60 provides the information of the image based on the viewing permission. If a requestor does not have permission to view the image, the information and the image are not provided. If the access of the information on the image is limited, the server 60 determines if the user 15 is part of the class that nevertheless has access. This may be determined by querying the profile of the requestor. The information to be presented to the requestor, viewer or potential viewer may be limited by the date of view, the location of the viewer, or some other aspect of the viewer that the system 10 knows about the user 15 and informs the server 60. If the access of the information on the image is authorized, the server 60 sends the information about the image to the view of the user 15. For example, advertisements are shown along the bottom or overlaid over the view. Options to access historical information about the image becomes available with a radio button. A plurality of three-dimensional images may appear overlaid over the images about information related to image. If the image has not yet been set as a digital geographical marker, the user 15 may choose to create a digital geographical marker and impose the viewing permission on the image by embedding the one or more attributes in the image such as a text, a location, a video or a hyperlink and sends the marker to the server via communication network 70. In some embodiments, the communication network 70 may include a wired communication network such as LAN. In another embodiment, the communication network 70 may include a wireless communication network such as 2G, 3G, 4G, LTE, HSDPA, WiFi, Bluetooth, Zigbee, Low Power WAN and the like.

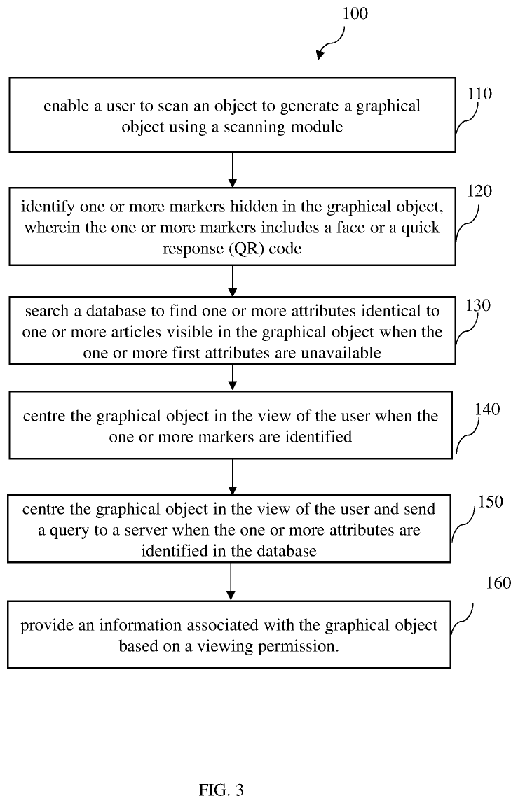

FIG. 3 is flow chart representing the steps involved in a method 100 for identification of a marker in a graphical object in accordance with an embodiment of the present disclosure. The method 100 includes enabling a user to scan an object to generate a graphical object using a scanning module in step 110. In one embodiment, enabling the user to scan the object to generate a graphical object using a scanning module may include enabling the user to scan the object to generate an image, a video, an augmented reality video or a virtual reality video. In some embodiments, enabling the user to scan the object to generate a graphical object using a scanning module may include enabling the user to scan the object from a visual entity, a printed material, an electronic display unit, or a projected visual information to generate the graphical object. In such embodiment, enabling the user to scan the object to generate a graphical object using a scanning module may include enabling the user to scan the object to generate the graphical object using a camera or a scanner of an electronic device.

The method and system 100 also includes identifying one or more markers hidden in the graphical object, wherein the one or more markers includes a face, a barcode, a digital tag or a quick response (QR) code in step 120. The method 100 further includes searching a database to find one or more attributes identical to one or more articles visible in the graphical object when the one or more attributes are unavailable in step 130. In one embodiment, searching a database to find one or more attributes identical to one or more articles visible in the graphical object when the one or more attributes are unavailable may include searching an image library in the database to identify if one or more articles present in the image is identical to one or more attributes in the image library.

The method and system 100 further includes centering the graphical object in the view of the user when the one or more markers are identified in step 140. The method 100 further includes centering the graphical object in the view of the user and send a query to a server when the one or more attributes are identified in the database in step 150. In a specific embodiment, the method 100 may include identifying a viewing permission for a centered graphical object. In such embodiment, identifying the viewing permission for the centered graphical object may include identifying a limitation of a date of view, a limitation of a location of the viewer or a plurality of aspects of the viewer that the system knows about the viewer for the centered graphical object.

The method and system 100 further includes providing an information associated with the graphical object based on the viewing permission in step 160. In one embodiment, providing an information associated with the graphical object based on the viewing permission may include providing to the potential viewer requesting the information location information, translation information, historic description or current news with the graphical object based on the viewing permission. In some embodiments, providing the information associated with the graphical object based on the viewing permission may include providing the information associated with the graphical object from online educational sources such as books, encyclopedias, dictionaries, translators, and the like. In a specific embodiment, the method 100 may include creating a marker for the graphical object of the scanned view. In one embodiment, creating a marker may include creating a marker by embedding one or more attributes in the graphical object, wherein the one or more attributes may include a video, an augmented reality video, a 3-dimensional content, a hyperlink or a text. In a preferred embodiment, the method 100 may include centering the graphical object in the view of the user when the one or more markers is created.

Various embodiments of the system and method for identification of the marker in the graphical object described above enable a fast and efficient method to extract the information of a view by scanning the view and identifying the marker.

Furthermore, the system utilizes the camera of the portable electronic device which expands application of the scanning module and offers convenience to the user. In addition, because the identification module searches for information related to an image captured using the camera, the user may acquire the desired information simply by photographing an image of the view when in location.

While specific language has been used to describe the invention, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, order of processes described herein may be changed and are not limited to the manner described herein. Moreover, the actions of any flow diagram need not be implemented in the order shown; nor do all of the acts need to be necessarily performed. Also, those acts that are not dependent on other acts may be performed in parallel with the other acts. The scope of embodiments is by no means limited by these specific examples.

We claim:

1. A system for identifying attributes in an image; the system comprising:
generating a first image with a portable electronic device;
identifying one or more geo-markers in the image;
analyzing the first image to locate attributes;
searching a database for one or more prior images with similar attributes or identifying the first image as similar to one or more prior images in the database, the prior images being submitted to the database by a prior user;
centering the first image in the view of a current user on the portable electronic device; and
providing an information from the database associated with the first image to the current user.

2. A system as set forth in claim 1, further comprising:
searching for a geolocation marker identifying a location where the prior user has captured the prior image; and
if the current user is on the same location and viewing the same image as the prior user, centering the first image to coincide with the prior image.

3. A system as set forth in claim 1, wherein after the first image is centered, applying additional graphics around the perimeter such as advertising or instructions.

4. A system as set forth in claim 1, wherein the prior images in the database include a profile of the prior user who scanned and submitted the prior image.

5. A system as set forth in claim 1, wherein when an identical or similar prior image to the first image is located in the database, providing to the current user the profile information of the prior user that submitted the prior image.

6. A system as set forth in claim 1, wherein the one or more markers in the first image are a face, a barcode, a digital tag, or a QR code.

7. A system as set forth in claim 6, wherein the database provides information from a prior image that shares a common marker with the first image.

8. A system as set forth in claim 1, wherein the information provided from the database is a 3-dimensional image, a geolocation, a translation, a historic description, or a current news.

9. A system as set forth in claim 1, wherein the information provided from the database is obtained from online books, encyclopedias, dictionaries, or translators.

10. A system as set forth in claim 1, wherein the information provided is overlaid over the first image in the view of the current user.

11. A system as set forth in claim 1, wherein the information provided is displayed to the current user, and the current user can toggle the display on and off.

12. A system for providing information based on the permissions of an image; the system comprising:
creating a profile for a current user;
generating a first image comprising one or more markers or attributes with a portable electronic device;
finding one or more prior images with similar markers or attributes in a database or identifying the first image as similar to one or more prior images in the database;
querying a server for a set of permissions associated with the prior images;
comparing the profile of the current user to the set of permissions;
providing an information from the database associated with the first image to the current user if the current user has permission to view the information.

13. A system as set forth in claim 12, wherein the prior images in the database include an image profile comprising the identity of a prior user who generated and submitted the prior images.

14. A system as set forth in claim 12, wherein the prior images in the database include an image profile comprising a geolocation of the prior image.

15. A system as set forth in claim 12, wherein the set of permissions limits access to the prior image based on the date of viewing or location of the current user.

16. A system as set forth in claim 12, wherein the set of permissions limits access to the prior image based on an attribute of the profile of the current user.

17. A system as set forth in claim 12, wherein the set of permissions can be configured to a private permission allowing only a specific list of other users to view the prior image, or a public permission allowing any other user to view the prior image.

18. A system for embedding attributes in an image; the system comprising:
generating an image with a portable electronic device;
embedding a video, an augmented reality video, a 3-dimensional content, a barcode, a QR code, a digital tag, a hyperlink, or a text in the image;
selecting a viewing permission set;
embedding the viewing permission in the image;
storing the image with the embedded markers and viewing permission set in a database;
centering the image in the view of a current user on the portable electronic device.

19. A system as set forth in claim 18, wherein the viewing permission set can be configured to a private permission allowing only a specific list of other users to view the image, or a public permission allowing any other user to view the image.

20. A system as set forth in claim 18, wherein the database is configured to use the embedded attributes to categorize similar images together.
